(19) United States
(12) Patent Application Publication
(10) Pub. No.: US 2012/0169318 A1
(43) Pub. Date: Jul. 5, 2012

(54) LOAD DRIVING DEVICE

(75) Inventor: Takahito Jou, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/394,956

(22) PCT Filed: Sep. 17, 2010
(86) PCT No.: PCT/JP2010/066220

§ 371 Date: Mar. 8, 2012

(30) Foreign Application Priority Data
Sep. 29, 2009 (JP) 2009-225227

(51) Int. Cl. G05F 1/56

(52) U.S. Cl. 323/311

(57) ABSTRACT

The source of FET is connected to a battery voltage +V through a fuse, while the drain of FET is connected to an electric load. The gate of FET is connected to the connection node of a capacitor and a resistor of a serial circuit configured with the capacitor the resistor. The serial circuit is connected in series with FET. The source and drain of FET are connected to both ends of the capacitor. The gate of FET is connected to the connection node of resistors. The resistor is connected to FET.

### TECHNICAL FIELD

The present invention relates to a load driving device for driving an electric load by a semiconductor switch.

### DESCRIPTION OF RELATED ART

A vehicle such as an automobile is provided with an alternator (e.g. in-vehicle generator or AC generator), a battery and the like. The electric power generated by the alternator in cooperation with an engine is used for charging the battery, while the electric power from the battery is supplied to an electric load mounted in the vehicle.

In order to supply electric power from the battery to the electric load, a semiconductor switch such as FET (Field-Effect Transistor) is interposed on an electrical path between the battery and electric load, and is turned on or off to control driving of the electric load. For example, an in-vehicle electronic circuit is disclosed which performs PWM control on the FET with a microcomputer to drive an electric load such as a lamp (see Patent Document 1, for example).

### PRIOR ART REFERENCES

Patent Document 1: Japanese Patent Application Laid-Open No. 2003-154903

### SUMMARY OF THE INVENTION

### Problems to be Solved by the Invention

In the in-vehicle electronic circuit of Patent Document 1, however, a bias voltage obtained by dividing a battery voltage in a serial circuit with plural resistors is applied to the gate of FET. This causes current to constantly flow in the serial circuit to continuously generate a desired bias voltage in order to maintain FET in the ON state. It is, however, desired to reduce unnecessary consumption current as much as possible in order to suppress the consumption power of the battery, since the battery has a limited capacity.

The present invention has been made in view of the above circumstances. An object of the invention is to provide a load driving device that can reduce the current for maintaining FET in the ON state compared to the conventional case.

### Means for Solving Problems

A load driving device according to the first aspect of the invention provided with an FET turned on or off in accordance with a magnitude of a bias voltage and driving an electric load includes a serial circuit including a resistor and a capacitor, the bias voltage being obtained by dividing a voltage by the serial circuit.

The load driving device according to the second aspect of the invention includes, in the first aspect of the invention, a first switch circuit connected in parallel with the capacitor, the first switch circuit being turned on or off to change a voltage of the capacitor, making the FET in an ON state or an OFF state.

The load driving device according to the third aspect of the invention includes, in the first or second aspect of the invention, a second switch circuit connected in series with the serial circuit, the second switch circuit being turned on to charge the capacitor, making the FET in the ON state.

The load driving device according to the fourth aspect of the invention includes, in the third aspect of the invention, a control unit for performing control to periodically turn on or off the second switch circuit.

The load driving device according to the fifth aspect of the invention includes, in the third aspect of the invention, a detection circuit for detecting a voltage of the capacitor, and a control unit for comparing the voltage detected by the detection circuit with a threshold voltage to perform control to turn on or off the second switch circuit.

According to the first aspect of the invention, the serial circuit including the resistor and capacitor is provided. The serial circuit divides the voltage (the voltage supplied from a battery, for example) to obtain the bias voltage. The FET is turned on or off in accordance with the magnitude of the bias voltage. For example, the bias voltage may be increased to turn on FET, while the bias voltage may be reduced to turn off FET. Since the capacitor is included in the serial circuit generating the bias voltage, little current flows in the capacitor once the voltage necessary for the bias voltage is charged to the capacitor. The current for maintaining FET in the ON state can be reduced compared to the conventional case where current is constantly flowing.

According to the second aspect of the invention, the first switch circuit connected in parallel with the capacitor is provided. The first switch circuit is turned on or off to change the voltage of the capacitor, making the FET in the OFF or ON state. The first switch circuit may be configured with, for example, one-stage or multi-stages FET. If, for example, the first switch circuit is turned on, the both ends of the capacitor are short-circuited through the first switch circuit and thus the voltage of the capacitor is lowered. This reduces the bias voltage and makes FET in the OFF state. If, on the other hand, the first switch circuit is turned off, the both ends of the capacitor are opened through the first switch circuit and thus the capacitor is charged. This increases the bias voltage and makes FET in the ON state. Accordingly, the current for maintaining FET in the ON state can be reduced while driving of the electric load can be controlled by controlling FET for its ON or OFF state.

According to the third aspect of the invention, the second switch circuit connected in series with the serial circuit is provided. The second switch circuit is turned on to charge the capacitor, making FET in the ON state. The second switch circuit may be configured with, one-stage or multi-stages FET. This can prevent the voltage charged to the capacitor from being lowered due to, for example, leakage current and reducing the bias voltage.

According to the fourth aspect of the invention, the control unit for controlling the second switch circuit so as to be periodically turned on or off is provided. The control unit periodically turns on the second switch circuit to charge the capacitor, making FET in the ON state. The cycle of ON and OFF may be set such that the bias voltage is not smaller than the voltage at which FET cannot be maintained in the ON state because of, for example, discharge of the voltage charged to the capacitor due to leakage current or the like. This can reduce unnecessary consumption current while maintaining FET in the ON state.

According to the fifth aspect of the invention, provided are: the detection circuit detecting the voltage of the capacitor; and the control circuit for comparing the voltage detected by the detection circuit with the threshold voltage to control the second switch circuit to be turned on or off. The control unit turns on the second switch circuit in accordance with the detected voltage of the capacitor to charge the capacitor, making FET in the ON state. The threshold voltage may be set to be not smaller than the voltage at which the bias voltage cannot maintain FET in the ON state because, for example, the voltage charged to the capacitor is discharged due to leakage current or the like. This can reduce unnecessary consumption current while maintaining FET in the ON state.

### Effects of Invention

According to the present invention, the current for maintaining FET in the ON state can be reduced compared to the conventional case.

### BRIEF DESCRIPTION OF SEVERAL VIEWS OF DRAWINGS

FIG. 1 is a circuit diagram illustrating an example of a configuration of a load driving device according to an embodiment of the present invention;

FIG. 2 is a time chart illustrating the operation of the load driving device according to an embodiment of the present invention;

FIG. 3 is a circuit diagram illustrating an example of a configuration of a load driving device according to Embodiment 2 of the present invention; and

FIG. 4 is a circuit diagram illustrating an example of a configuration of a load driving device according to Embodiment 3 of the present invention.

### DESCRIPTION OF PREFERRED EMBODIMENTS

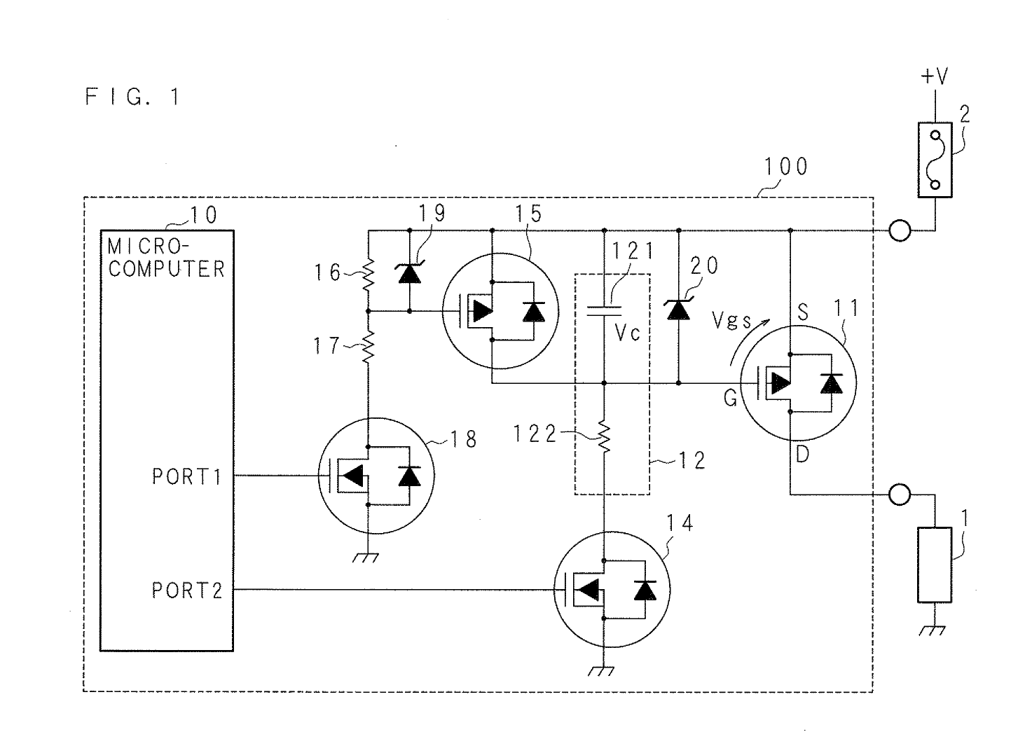

A load driving device according to the present invention will be described below with reference to drawings illustrating an embodiment thereof. FIG. 1 is a circuit diagram illustrating an example of the configuration of a load driving device 100 according to the present embodiment. The load driving device 100 includes: a p-channel FET 11 as the FET turned on or off in accordance with the magnitude of a bias voltage Vgs; a serial circuit 12 with a resistor 122 and a capacitor 121 as the serial circuit including a resistor and a capacitor; a p-channel FET 15 as the first switch circuit connected in parallel with the capacitor 121; a resistor 16; a resistor 17, an n-channel FET 18; an n-channel FET 14 as the second switch circuit connected in series with the serial circuit 12; and a microcomputer 10 as the control unit for controlling the n-channel FET 14 to be turned on or off.

As shown in FIG. 1, the source of FET 11 is connected to a battery voltage +V through a fuse 2, while the drain of FET 11 is connected to an electric load 1. The gate of FET 11 is connected to a connection node of the capacitor 121 and resistor 122 in the serial circuit 12 configured with the capacitor 121 and resistor 122. Moreover, the serial circuit 12 is connected in series with FET 14 serving as the second switch circuit. Accordingly, a voltage (voltage Vc of capacitor 121) obtained by dividing the battery voltage +V at the capacitor 121 and resistor 122 is applied between the gate and source of FET 11 as a bias voltage Vgs.

The source and drain of FET 15 configuring the first switch circuit are connected to both ends of the capacitor 121. The gate of FET 15 is connected to the connection node of the resistor 16 and 17. The resistor 17 is connected to FET 18 configuring the first switch circuit.

The gate of FET 18 is connected to a port 1 of the microcomputer 10 serving as a control unit. The gate of FET 14 is connected to a port 2 of the microcomputer 10. A zener diode 20 is connected between the gate and source of FET 11 for protecting FET from overvoltage, noise or the like. Furthermore, a zener diode 19 is connected between the gate and source of FET 15 for protecting FET from overvoltage, noise or the like.

When a desired positive voltage is output from the port 1 of microcomputer 10, the FET 18 is turned on while the gate potential of FET 15 is lowered, making FET 15 in the ON state. Here, the both ends of capacitor 121 are short-circuited through the source and drain of FET 15, lowering the voltage of capacitor 121. If, on the other hand, no voltage is output from the port 1 (in the case of zero potential), FET 18 is turned off, raising the gate potential of FET 15 which will be in the OFF state. Here, the both ends of capacitor 121 are opened through the source and drain of FET 15, charging the capacitor 121 which will have a raised voltage.

When a desired positive voltage is output from the port 2 of microcomputer 10, the FET 14 is turned on, charging the capacitor 121 which will have a raised voltage. If, on the other hand, no voltage is output from the port 2 (in the case of zero potential), FET 14 is turned off and the capacitor 121 is not charged.

As described above, a voltage obtained by dividing the battery voltage +V by the serial circuit 12 including the resistor 122 and capacitor 121 is used as the bias voltage Vgs of FET 11 driving the electric load. FET 11 is turned on when the bias voltage Vgs becomes larger than a predetermined threshold, while the FET 11 is turned off when the bias voltage Vgs becomes smaller than the predetermined threshold. Since the serial circuit 12 generating the bias voltage Vgs includes the capacitor 121, little current flows in the capacitor 121 once voltage Vc necessary for the bias voltage Vgs is charged to the capacitor 121. Accordingly, current for maintaining FET 11 in the ON state can be reduced compared to the conventional case where current (of approximately several mA to several tens of mA, for example) is constantly flowing. In particular, the power-saving effect is more increased as the time for using FET 11 in the ON state is longer. Note that FET 14, FET 15, FET 18 and the like may be omitted.

Furthermore, in the case with the conventional bias circuit including a serial circuit with only a resistor, current flowing in the serial circuit may be reduced by increasing the resistance value. The increase in the resistance value generates a larger effect of noise, causing a problem of malfunction in FET or a problem of a reduced bias voltage which may be difficult to turn on FET. No such problems arise in the present embodiment.

Moreover, if a switch circuit configured with two-stages FET including FET 15 and FET 18 is provided, FET 18 and FET 15 may be turned on or off to change the voltage Vc of capacitor 121 to make FET 11 in the OFF or ON state. For example, if FET 18 and FET 15 are turned on, the both ends of capacitor 121 are short-circuited through FET 15, so that the voltage of capacitor 121 is lowered while the bias voltage Vgs is reduced, making FET 11 in the OFF state. Moreover, when FET 18 and FET 15 are turned off, the both ends of the capacitor 121 are opened through FET 15, so that the capacitor 121 is charged while the bias voltage Vgs is increased, allowing FET 11 to be in the ON state. Accordingly, the current for maintaining FET 11 in the ON state can be reduced while FET 11 may be controlled to be turned on or off, to control driving of the electric load.

When FET 14 is included, FET 14 is turned on to charge the capacitor 121, making FET 11 in the ON state. Note that, though one FET 14 is provided in the example of FIG. 1, multi-stage FET may be used to configure the second switch circuit. This can prevent the voltage charged to the capacitor 121 from lowering due to, for example, leakage current, reducing the bias voltage Vgs.

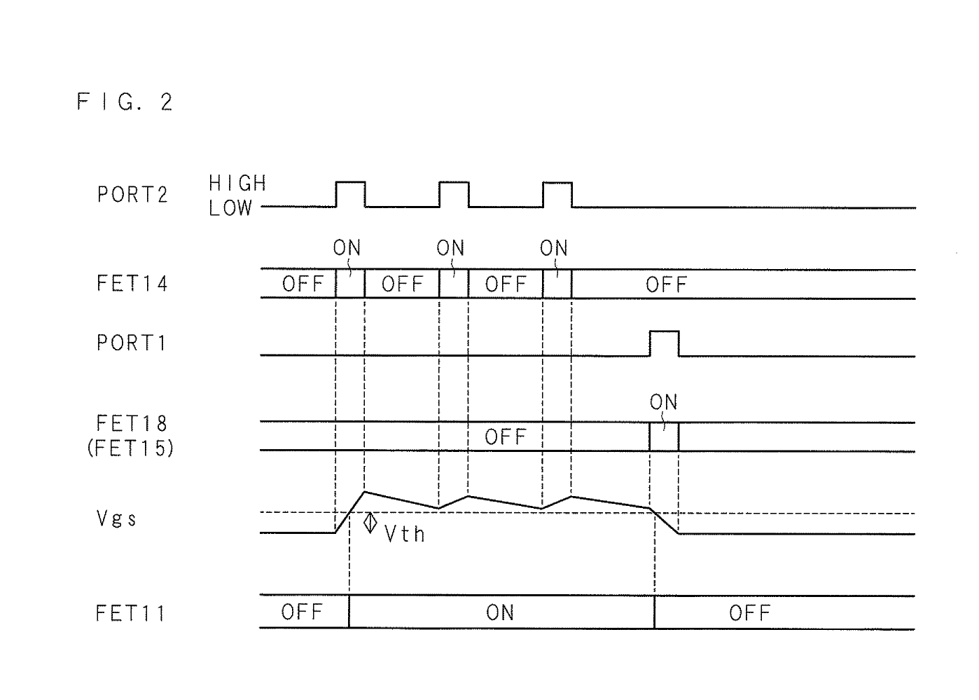

FIG. 2 is a timing chart illustrating the operation of the load driving device 100 according to the present embodiment. As shown in FIG. 2, the microcomputer 10 outputs a rectangular pulse waveform (high, low) from the port 2 at a predetermined timing. That is, positive voltage is periodically output from the port 2. When the positive voltage is output from the port 2, FET 14 is turned on and the capacitor 121 is charged. Thus, as the voltage Vc (i.e. bias voltage Vgs) of capacitor 121 becomes larger than the threshold Vth, FET 11 is changed from the OFF state to the ON state.

When the positive voltage stops being output from the port 2, FET 14 is turned off and charging to the capacitor 121 is stopped. The charge applied to the capacitor 121 is reduced due to leakage current flowing through FET 11 and the like, lowering the voltage Vc (i.e. bias voltage Vgs) of the capacitor 121. Before the voltage Vc (i.e. bias voltage Vgs) of capacitor 121 becomes smaller than the threshold Vth, a positive voltage is output from the port 2 to restart charging to the capacitor 121, in order to maintain FET 11 in the ON state.

The predetermined timing described above may be set that the bias voltage Vc becomes not smaller than the voltage at which the charge applied to the capacitor 121 is discharged due to leakage current or the like and thus the bias voltage Vc cannot maintain FET 11 in the ON state. The predetermined timing can be stored in the microcomputer 10 in advance. Thus, unnecessary consumption current can be reduced because of the capacitor 121, while FET 11 is maintained in the ON state.

When a positive voltage is output from the port 1, FET 18 and FET 15 become in the ON state. The charge applied to the capacitor 121 is discharged through FET 15, and the voltage Vc of capacitor 121 is lowered. This lowers the bias voltage Vgs and makes FET 11 in the OFF state to stop driving of the electric load 1.

### Embodiment 2

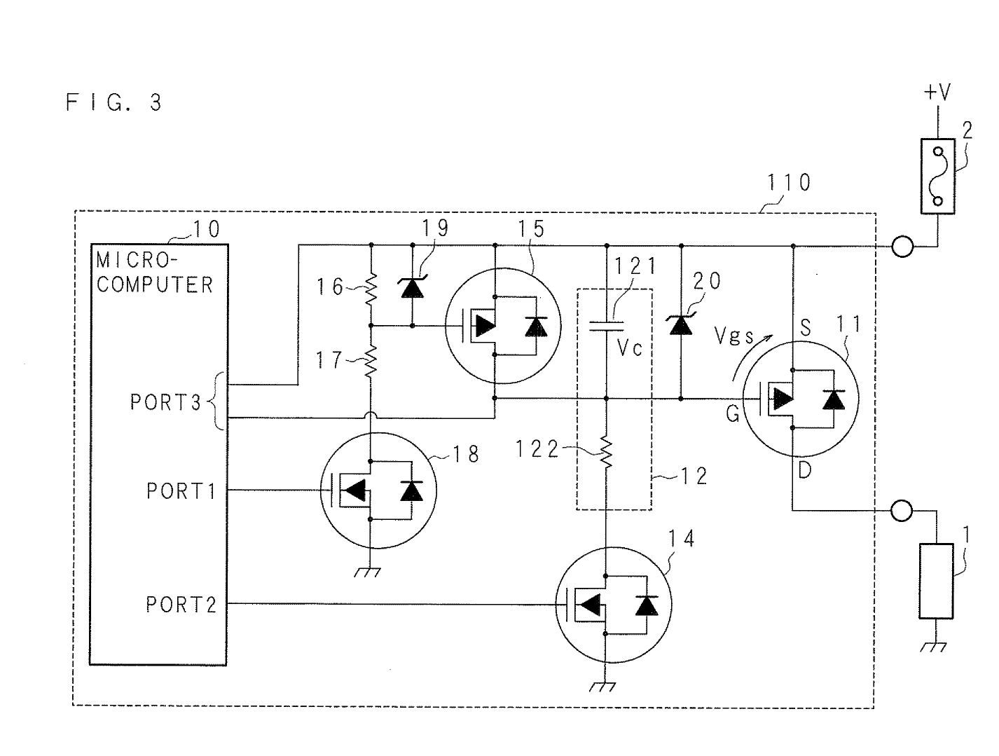

FIG. 3 is a circuit diagram illustrating an example of the configuration of a load driving device 110 according to Embodiment 2 of the present invention. In the above-described embodiment, though the rectangular pulse waveform is output from the port 2 at a preset timing, the rectangular pulse waveform may also be output from the port 2 in accordance with the voltage Vc of capacitor 121. As shown in FIG. 3, in Embodiment 2, the microcomputer 10 is provided with a port 3 as a detection circuit for detecting the voltage of capacitor 121.

The microcomputer 10 compares the detected voltage Vc of capacitor 121 with the threshold voltage. The threshold voltage may be set that the bias voltage Vgs becomes not smaller than the voltage at which, for example, the voltage charged to the capacitor 121 is discharged due to leakage current or the like, inhibiting the bias voltage Vgs from maintaining FET 11 in the ON state. The microcomputer 10 intermittently outputs a positive voltage from the port 2 such that the voltage Vc of capacitor 121 is not smaller than the threshold voltage. Accordingly, FET 14 is intermittently turned on to charge the capacitor 121 and to make FET 11 in the ON state. Thus, unnecessary consumption current can be reduced while maintaining FET 11 in the ON state.

In the above-described embodiment, FET 14 may be turned on constantly instead of being turned on intermittently or at a predetermined timing. In such a case also, if the capacitor 121 is once charged and the voltage Vc of the capacitor 121 is made equal to the battery voltage +V, current does not flow in the serial circuit 12, suppressing unnecessary consumption current.

### Embodiment 3

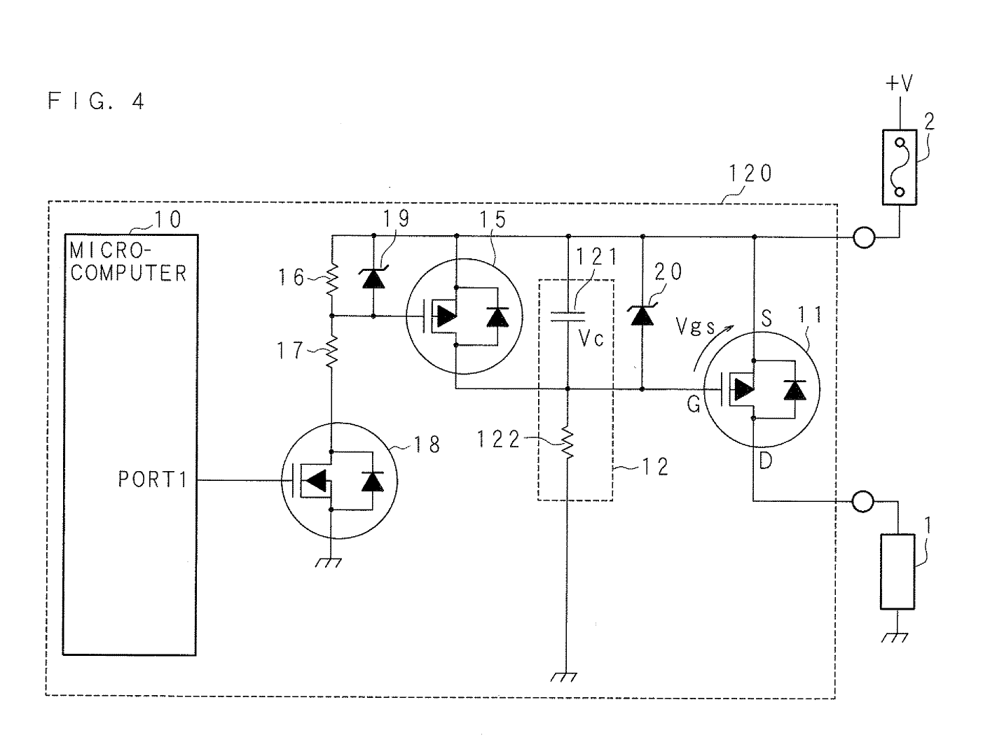

FIG. 4 is a circuit diagram illustrating an example of the configuration of a load driving device 120 according to Embodiment 3 of the present invention. Embodiment 3 is different from the embodiments described above in terms of not including FET 14. As shown in FIG. 4, if no voltage is output from the port 1 (in the case of zero potential), FET 18 and FET 15 are turned off to open the both ends of the capacitor 121. Here, a voltage obtained by dividing the battery voltage +V with the serial circuit 12 including the resistor 122 and capacitor 121 is used as the bias voltage Vgs of FET 11 driving an electric load. Thus, the bias voltage Vgs becomes larger than the predetermined threshold, making FET in the ON state. Since the serial circuit 12 generating the bias voltage Vgs includes the capacitor 121, little current flows in the capacitor 121 once the voltage Vc necessary for the bias voltage Vgs is charged to the capacitor 121. Accordingly, the current for maintaining FET 11 in the ON state can be reduced compared to the conventional case where current is constantly flowing.

When a positive voltage is output from the port 1, FET 18 and FET 15 are turned on, while the capacitor 121 is short-circuited by FET 15. The charge applied to the capacitor 121 is discharged through FET 15, lowering the voltage Vc of capacitor 121. This reduces the bias voltage Vgs and makes FET 11 in the OFF state, allowing driving of the electric load 1 to be stopped.

Though the serial circuit includes one resistor and one capacitor in the embodiment above, other elements such as a resistor, a capacitor and the like may further be included.

In the embodiment above, a capacitor may be used instead of the resistor 16.

In the embodiments described above, the p-channel FET may be replaced with the n-channel FET and the n-channel FET may be replaced with the p-channel FET, while the positive voltage and the ground level potential may be replaced with the ground level potential and the negative voltage, to realize a similar configuration.

Though one electric load is included in the embodiment described above, it is not limited thereto. It is also possible to include more than one electric loads. Here, one FET may be provided for driving plural electric loads that can be concurrently controlled. Furthermore, when more than one FETs are provided for driving electric load, the gates of the FETs may be collected together to control the ON state or OFF state of the plural FETs with one serial circuit 12.

The embodiments disclosed herein are illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

### DESCRIPTION OF REFERENCE CODES

1 electric load
10 microcomputer (control unit)
11 p-channel FET (FET)
12 serial circuit
121 capacitor
122 resistor
14 n-channel FET (second switch circuit)
15 p-channel FET (first switch circuit)
18 n-channel FET (first switch circuit)

1-5. (canceled)

6. A load driving device including an FET turned on or off in accordance with a magnitude of a bias voltage and driving an electric load, comprising
a serial circuit including a resistor and a capacitor, wherein
a voltage is divided by the serial circuit to obtain the bias voltage.

7. The load driving device according to claim 6, comprising
a first switch circuit connected in parallel with the capacitor, wherein
the first switch circuit is turned on or off to change a voltage of the capacitor, making the FET in an ON state or an OFF state.

8. The load driving device according to claim 6, comprising
a second switch circuit connected in series with the serial circuit, wherein
the second switch circuit is turned on to charge the capacitor, making the FET in the ON state.

9. The load driving device according to claim 7, comprising
a second switch circuit connected in series with the serial circuit, wherein
the second switch circuit is turned on to charge the capacitor, making the FET in the ON state.

10. The load driving device according to claim 8, comprising
a control unit for performing control to periodically turn on or off the second switch circuit.

11. The load driving device according to claim 9, comprising
a control unit for performing control to periodically turn on or off the second switch circuit.

12. The load driving device according to claim 8, comprising:
a detection circuit for detecting a voltage of the capacitor; and
a control unit for comparing the voltage detected by the detection circuit with a threshold voltage to perform control to turn on or off the second switch circuit.

13. The load driving device according to claim 9, comprising:
a detection circuit for detecting a voltage of the capacitor; and
a control unit for comparing the voltage detected by the detection circuit with a threshold voltage to perform control to turn on or off the second switch circuit.
